(19) United States
(12) Patent Application Publication
(10) Pub. No.: US 2006/0162265 A1
(43) Pub. Date: Jul. 27, 2006

(54) Simulated window transom

(76) Inventors: Edward L. Schield, Medford, WI (US); Emory M. Budzinski, Mosinee, WI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/034,467

(22) Filed: Jan. 13, 2005

(51) Int. Cl. E06B 3/26

(52) U.S. Cl. 52/202

(57) ABSTRACT

A double hung window assembly includes a frame having horizontally spaced-apart first and second vertically extending stiles and upper and lower frame members extending between and interconnecting the first and second stiles to form a vertically enlarged frame opening that is generally quadrilateral in shape. The window assembly includes a bottom window sash that is movably disposed in a lower portion frame opening. The bottom window sash includes a generally quadrilateral first frame having an enlarged first window opening therethrough, and a lower window pane mounted to the first frame in the first window opening. The first frame has vertically spaced-apart horizontal upper and lower edges defining a first height. The window assembly further includes an upper window sash that is movably disposed in an upper portion of the window opening. The upper window sash includes a second frame having an enlarged second window opening therethrough and an upper window pane having generally vertical inner and outer faces. The upper window pane is mounted to the second frame in the second window opening. The second frame has vertically spaced-apart upper and lower edges defining therebetween a second height that is substantially greater than the first height. A simulated transom member extends horizontally across a selected one of the inner and outer faces of the upper window pane. The simulated transom visually divides the upper window pane into an upper portion and a lower portion. The size and shape of the lower portion of the upper window pane is substantially similar to that of the first window opening of the first frame.

### BACKGROUND OF THE INVENTION

Various windows for houses, buildings, and the like have been developed. One type of window is a double hung window having two vertically sliding sashes, wherein each of the sashes includes a window pane that moves with the sash. Double hung windows may include a stationary third window pane that is mounted to the window frame above the upper sash. A cross rail extends across the lower edge of the stationary third window pane, and abuts a top rail of the upper sash to form a transom extending across the window. Single hung windows having a single sash may also include a stationary upper window pane and transom arrangement.

Existing transoms provide an appearance that is desirable in many applications. However, the additional complexity and parts required to mount a third window pane increase the costs of the window, and may create additional difficulties relating to cleaning and maintenance of the window.

### SUMMARY OF THE INVENTION

One aspect of the present invention is a double hung window assembly including a frame having horizontally spaced-apart first and second vertically extending stiles and upper and lower frame members extending between and interconnecting the first and second stiles to form a vertically enlarged frame opening that is generally quadrilateral in shape. The window assembly includes a bottom window sash that is movably disposed in a lower portion frame opening. The bottom window sash includes a generally quadrilateral first frame having an enlarged first window opening therethrough, and a lower window pane mounted to the first frame in the first window opening. The first frame has vertically spaced-apart horizontal upper and lower edges defining a first height. The window assembly further includes an upper window sash that is movably disposed in an upper portion of the window opening. The upper window sash includes a second frame having an enlarged second window opening therethrough and an upper window pane having generally vertical inner and outer faces. The upper window pane is mounted to the second frame in the second window opening. The second frame has vertically spaced-apart upper and lower edges defining therebetween a second height that is substantially greater than the first height. A simulated transom member extends horizontally across a selected one of the inner and outer faces of the upper window pane. The simulated transom visually divides the upper window pane into an upper portion and a lower portion. The size and shape of the lower portion of the upper window pane is substantially similar to that of the first window opening of the first frame.

Another aspect of the present invention is a double hung window assembly including a primary frame comprising horizontally spaced-apart first and second vertically extending stiles having first and second inwardly facing vertical guides. The primary frame further includes upper and lower frame members extending between and interconnecting the first and second stiles to form a horizontally and vertically enlarged frame opening that is generally quadrilateral in shape. A bottom window sash movably engages the first vertical guide, and includes a generally quadrilateral first frame and a lower window pane mounted to the first frame. The first frame has upper and lower edges defining a first height. An upper window sash movably engages the second vertical guide, and includes a second frame and an upper window pane mounted to the second frame. The upper window pane has generally vertically inner and outer faces, and the second frame has upper and lower outer edges defining therebetween a second height that is substantially greater than the first height. The window assembly further includes a simulated transom member extending horizontally across the outer face of the upper window pane. The simulated transom member visually divides the upper window pane into an upper portion and a lower portion.

Yet another aspect of the present invention is a window assembly including a frame comprising horizontally spaced-apart first and second vertically extending stiles and upper and lower frame members extending between and interconnecting the first and second stiles to form a horizontally and vertically enlarged frame opening that is generally quadrilateral in shape and defines a height and a width, wherein the height is substantially greater than the width. The window assembly also includes a window pane having generally inner and outer faces. The window pane is mounted to the frame in the enlarged frame opening and spans across the height and width thereof. A simulated transom member extends horizontally across the outer face of the window pane, and visually divides the upper window pane into an upper portion defining a first height and a lower portion defining a second height. The second height is substantially greater than the first height. The simulated transom member defines an outer face having at least one horizontally extending groove providing a transom-like appearance.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is an elevational view of a double hung window assembly including a simulated transom according to one aspect of the present invention;

FIG. 2 is a partially fragmentary, cross-sectional view of the window of FIG. 1 taken along the line II-II;

FIG. 3 is a partially fragmentary, cross-sectional view of the window of FIG. 2 taken along the line III-III; FIG. 2;

FIG. 4 is a single hung window having a simulated transom according to another aspect of the present invention;

FIG. 5 is a partially fragmentary cross-sectional view of the window of FIG. 4 taken along the line V-V; FIG. 4;

FIG. 6 is a partially fragmentary, cross-sectional view of the window of FIG. 4 taken along the line VI-VI; FIG. 4;

FIG. 7 is a double hung window according to another aspect of the present invention;

FIG. 8 is a view of a double hung window according to another aspect of the present invention;

FIG. 9 is a double hung window according to another aspect of the present invention; and

FIG. 10 is a double hung window according to yet another aspect of the present invention.

### DETAILED DESCRIPTION OF PREFERRED EMBODIMENT

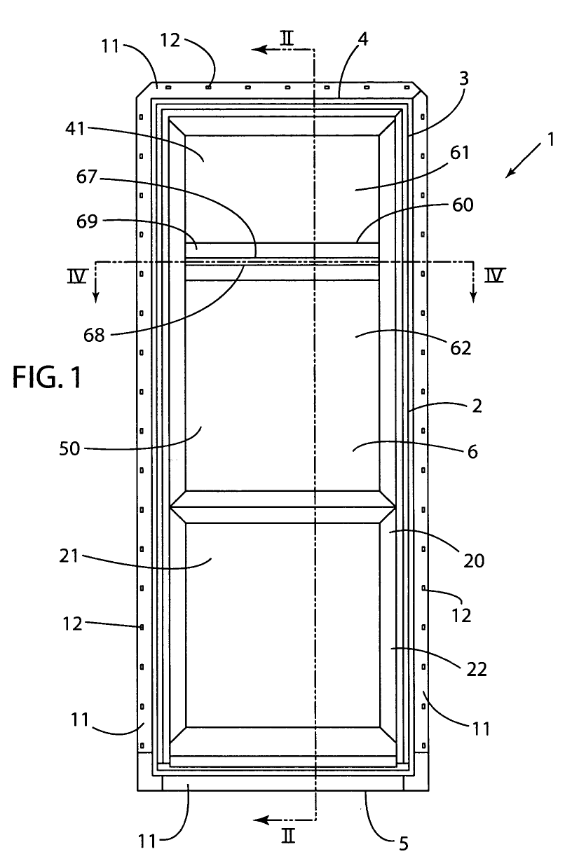

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a double hung window assembly 1 according to one aspect of the present invention includes a frame 2 having vertically extending stiles 3, and upper and lower frame members 4 and 5, respectively, that extend between and interconnect the stiles 3 to form a horizontally and vertically enlarged frame opening 6 that is generally quadrilateral in shape. Lower sash 20 and upper sash 40 are movably mounted to the frame 2 in opening 6. As discussed in more detail below, a window according to one aspect of the present invention includes a simulated transom 60 that extends across window pane 50 of movable upper sash 40. The simulated transom 60 provides an appearance that is similar to conventional transom arrangements utilized to provide a stationary window mounted above an upper sash.

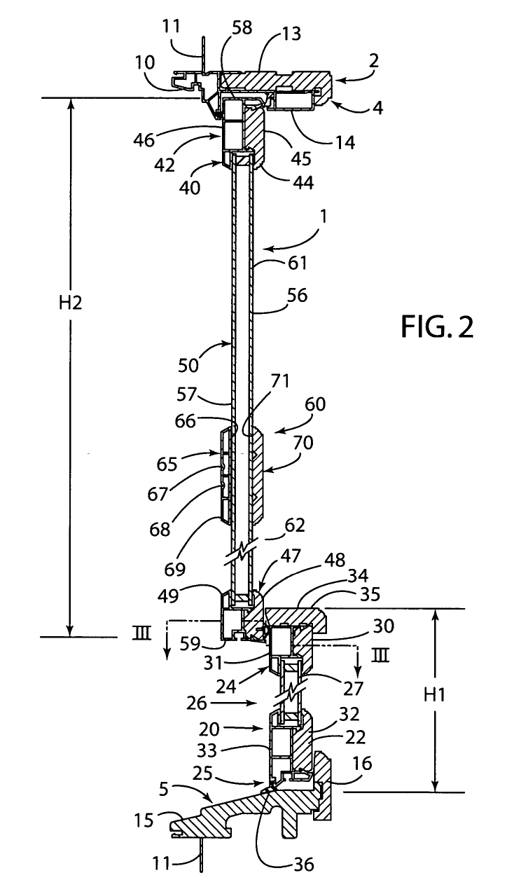

With further reference to FIG. 2, upper frame member 4 includes a vinyl extrusion 10 including an inner portion 14 and an integral nailing fin 11 having a plurality of openings 12 that receive nails or other suitable fasteners for securing the window assembly 1 to a building structure. In the illustrated example, the upper frame member 4 also includes a horizontally extending frame member 13 that is made of extruded PVC, wood, aluminum, or other suitable material. The horizontally extending lower frame member 5 includes a first sill member 15 that is made of cellular PVC or the like, and includes an integral nailing fin 11. A second lower sill member 16 faces an interior of the building structure, and may be made of wood or cellular PVC. It will be understood that the various window components described herein may be made from a variety of materials without departing from the present invention.

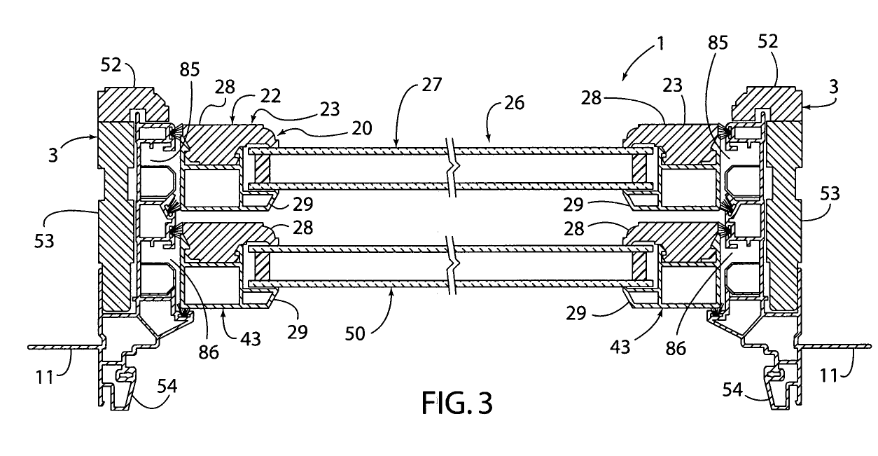

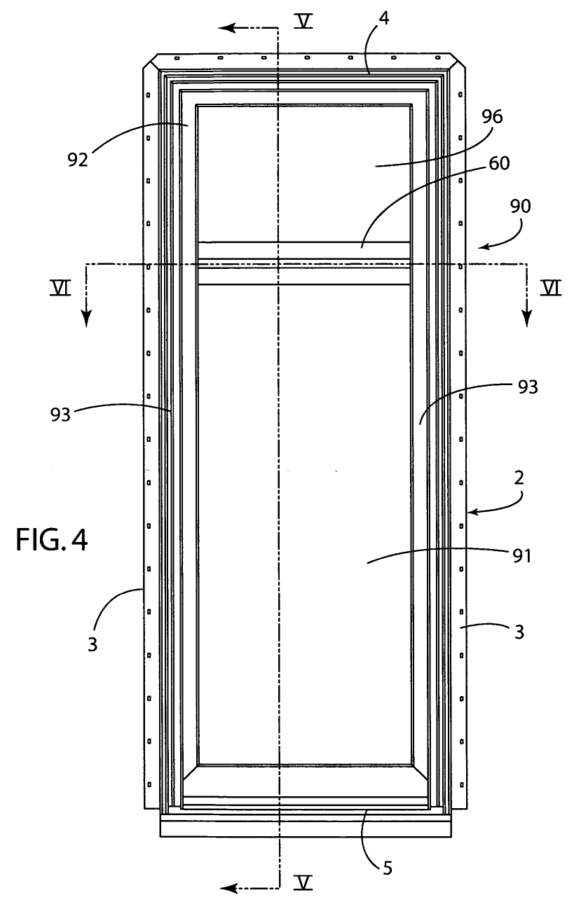

The bottom window sash 20 includes a generally quadrilateral first frame 22 including vertical side rails 23 (see also FIG. 3), a horizontal upper rail 24 and a horizontal bottom rail 25. The horizontal rails 24 and 25 extend between the vertical rails 23 to form an enlarged window opening 26, and a lower window pane 27 is mounted in the window opening 26. In the illustrated example, each of the vertical side rails 23 include a first rail member 28 that is made of wood or cellular PVC, and a second rail member 29 that is made of extruded PVC. The upper rail 24 includes an inner rail member 30 that is made of wood or cellular PVC, and an outer rail member 31 that is made of extruded PVC. The upper rail 24 also includes a third rail member 34 that is made of wood or cellular PVC. The lower rail 25 includes an inner rail member 32 that is made of wood or cellular PVC, and an outer rail member 33 that is extruded PVC. The first frame 22 includes an upper edge 35, and a lower edge 36 that define a first height H1 (FIG. 2).

Upper window sash 40 is movably disposed in an upper portion 41 of the window opening 6. The upper window sash 40 includes a frame 42 having vertical side frame rails 43 that have substantially the same construction as the vertical frame rails 23 of sash 20 described above. Top rail 44 of frame 42 includes an inner rail member 45 that is made of wood or cellular PVC, and an extruded outer rail member 46. Bottom rail 47 includes an inner rail member 48 that is made of wood or cellular PVC, and an outer rail member 49 that is made of extruded PVC. An upper window pane 50 is mounted to the frame 42. The upper window pane 50 includes a vertical inner face 56 and a vertical outer face 57. The frame 42 includes an upper edge 58 and lower edge 59 that define a second height H2 (FIG. 2) that is substantially greater than the first height H1.

With reference to FIG. 3, stiles 3 include first and second stile members 52 and 53 that are made of wood or cellular PVC. The stiles 3 further include a vertically extending extruded PVC member 54 having an integral nailing flange or fin 11 with openings 12 or the like. The vertical stiles 3 form a first guide 85 and a second guide 86 that provide for vertical movement of the bottom sash 20 and upper sash 40 in a known manner. It will be understood that the construction of the window frame 2 and the sash frames are substantially similar to that of existing prior art Peachtree® 300 Series windows. However, these prior art windows utilize a conventional transom and a separate, stationary pane of glass above the transom.

The simulated transom 60 according to one aspect of the present invention extends across the upper window pane 50, and visually divides the upper window pane 50 into an upper portion 61 and a lower portion 62. The simulated transom 60 includes a simulated outer transom member 65 having an inner surface 66 that abuts outer face 57 of upper window pane 50. Outer simulated transom member 65 is made of extruded PVC, and includes a first groove 67 and a second groove 68 in an outer face 69 of the outer simulated transom member 65 to thereby provide a visual appearance that is substantially similar to that of a conventional transom. Grooves 67 and 68 have an appearance that is substantially similar to a conventional clip (not shown) utilized to attach a traditional transom that is stacked over a conventional double hung window. Simulated transom 60 further includes an inner simulated transom member 70 that is made of wood or cellular PVC. Inner simulated transom member 70 includes an inner surface 71 that abuts vertical inner face 56 of upper window pane 50.

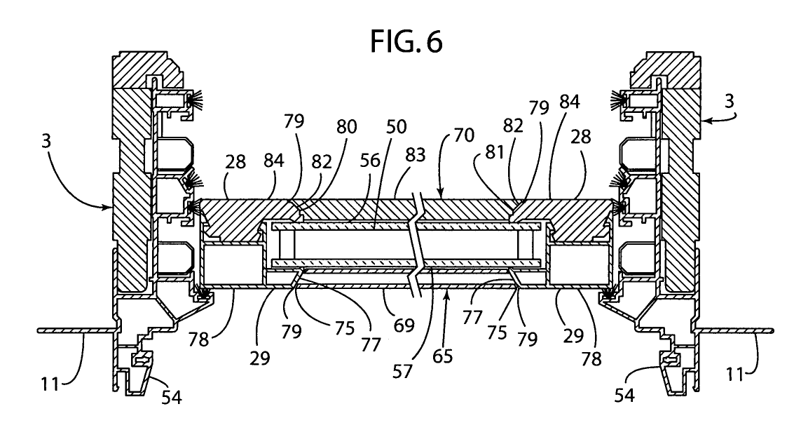

With further reference to FIG. 6, opposite ends 75 and 76 of outer simulated transom member 65 fit closely against the beveled edge surfaces 77 of rail members 29. Outer face 69 of simulated transom member 65 is substantially flush with outer face 78 of rail members 29. Commercially available two-sided tape 79 bonds the ends 75 and 76 of simulated transom member 65 to the rail members 29. Commercially available adhesive/sealing material may be utilized to bond simulated transom member 65 to the outer face 57 of window pane 50, and to bond and seal the window panes 27 and 50 to the sash frames. The opposite ends 80 and 81 of simulated inner transom member 70 fit closely against the beveled edge portions 82 of rail members 28, and tape 79 secures the simulated inner transom member 70 to the vertical rails 28 and/or the inner face 56 of window pane 50. Face 83 of simulated transom member 70 is substantially flush with the faces 84 of rail members 28.

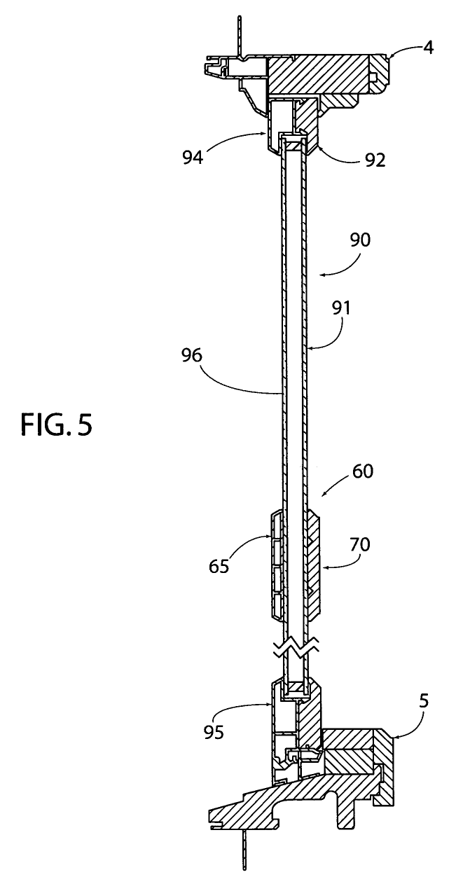

With further reference to FIGS. 5 and 6, a window assembly 90 according to another aspect of the present invention includes a frame 2, vertical stiles 3, upper frame member 4, lower frame member 5, and a simulated transom 60 that are substantially the same as the frame 2, stiles 3, upper frame member 4, lower frame member 5, and simulated transom 60 of the double hung window assembly 1. However, the window assembly 90 is a single hung “picture window” having a single window pane 91 that is mounted in a single sash frame 92. Sash frame 92 includes vertical side rails 93 that have substantially the same cross-sectional configuration as the vertical side rails 23 and 43 described in more detail above in connection with FIG. 3. Sash frame 92 also includes a horizontal top rail 94 that is substantially the same as top rail 24 of FIG. 2, and a horizontal bottom rail 95 that is substantially the same as rail 25, also described in more detail above in connection with FIG. 2.

The window assembly 90 provides the appearance of a single hung picture window having a conventional transom and a fixed upper pane of glass. However, only a single window pane 91 is utilized, thereby reducing the complexity and cost of the window.

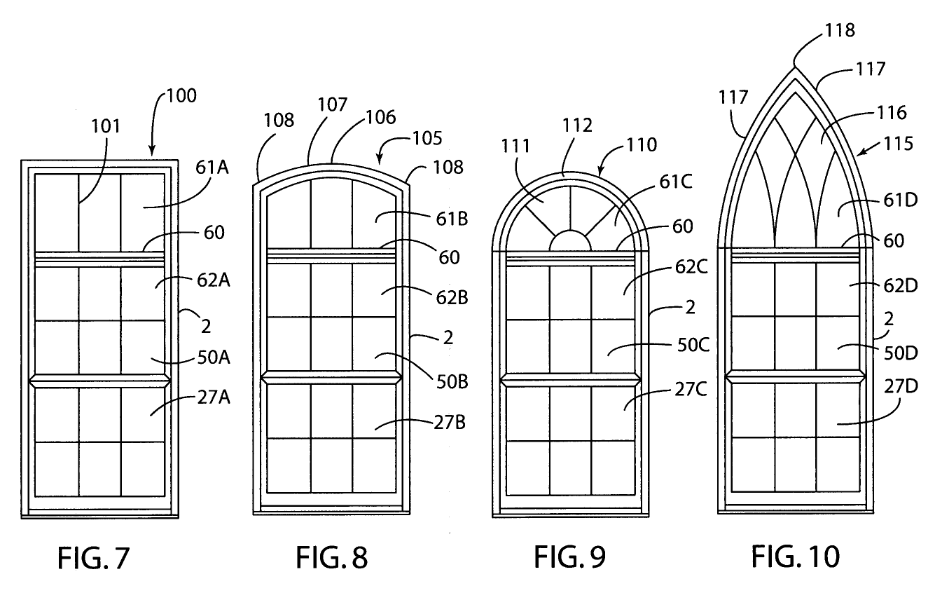

With further reference to FIGS. 7-10, window assemblies having various appearance/configurations may utilize a simulated transom 60. The window assembly 100 (FIG. 7) is substantially similar to the window assembly 1 described in more detail above in connection with FIGS. 1-3, except that the dimensions of the window assembly 100 are somewhat different, and the window 100 includes a plurality of grille bars 101. A window assembly 105 is similar to the window assembly 100, except that the upper window frame 106 is curved, thereby providing a center portion 107 having a height that is greater than the ends 108 of frame member 106. This provides an appearance that is substantially the same as a window having a conventional segment transom. Window assembly 110 (FIG. 9) includes an upper portion 111 having an appearance that is substantially similar to a conventional circle head transom 111. Window 110 includes an upper window frame member 112 having a semi-circular shape. Window assembly 115 (FIG. 10) includes a gothic transom 116 having curved upper window frame members 117 that extend upwardly to form a point 118. Each of the window assemblies 100, 105, 110 and 115 include a lower window pane 27A, 27B, 27C and 27D, respectively, and upper window panes 50A, 50B, 50C and 50D, respectively. The upper window panes are visually divided into upper portions 61A-61D and lower portions 62A-62D by the simulated transoms 60. The top sash of the windows 110 and 115 may be non-movably mounted to frame 2 utilizing a conventional pin (not shown) that removably retains the upper sash in the frame 2.

The simulated transom of the present invention provides the appearance of a conventional transom, and also provides a simplified construction that reduces costs, maintenance, and the like associated with conventional transom arrangements.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A double hung window assembly, comprising:
a frame comprising horizontally spaced-apart first and second vertically extending stiles and upper and lower frame members extending between and interconnecting the first and second stiles to form a horizontally and vertically enlarged frame opening that is generally quadrilateral in shape;
a bottom window sash movably disposed in a lower portion of the frame opening, the bottom window sash including a generally quadrilateral first frame having an enlarged first window opening therethrough and a lower window pane mounted to the first frame in the first window opening, the first frame having vertically spaced-apart horizontal upper and lower edges defining a first height;
an upper window sash movably disposed in an upper portion of the window opening, the upper window sash including a second frame having an enlarged second window opening therethrough and an upper window pane having generally vertical inner and outer faces and wherein the upper window pane is mounted to the second frame in the second window opening, the second frame having vertically spaced-apart upper and lower edges defining therebetween a second height that is substantially greater than the first height; and
a simulated transom member extending horizontally across a selected one of the inner and the outer faces of the upper window pane and visually dividing the upper window pane into an upper portion and a lower portion, the size and shape of the lower portion being substantially similar to that of the first window opening.

2. The window assembly of claim 1, wherein:
the upper edge of the second window frame extends horizontally, such that the upper portion of the upper window pane is substantially quadrilateral in shape.

3. The window assembly of claim 1, wherein:
the upper edge of the second window frame extends upwardly at the center, the upper portion of the upper window pane defining a center height at the central and outer heights at upper ends of the stiles, wherein the central height is substantially greater than the outer heights.

4. The window assembly of claim 3, wherein:
the upper portion of the upper window pane is semi-circular in shape.

5. The window assembly of claim 3, wherein:
the upper edge has a point at the center thereof and forms a gothic window shape.

6. The window assembly of claim 1, wherein:
the simulated transom member comprises an outer simulated transom member; and including:
an inner simulated transom member extending horizontally across the other of the inner and outer faces of the upper window pane opposite the outer simulated transom member.

7. The window assembly of claim 6, wherein:
each of the inner and outer simulated transom members define upper and lower edges that are substantially parallel to one another.

8. The window assembly of claim 7, wherein:
the upper and lower edges define heights of the inner and outer simulated transom members, and wherein the heights are substantially equal.

9. The window assembly of claim 8, including:
adhesive material bonding the inner and outer simulated transom members to the upper sash.

10. A double hung window assembly, comprising:
a primary frame comprising horizontally spaced-apart first and second vertically extending stiles having first and second inwardly facing vertical guides, the primary frame further including upper and lower frame members extending between and interconnecting the first and second stiles to form a horizontally and vertically enlarged frame opening that is generally quadrilateral in shape;
a bottom window sash movably engaging the first vertical guide, and including a generally quadrilateral first frame and a lower window pane mounted to the first frame, the first frame defining a first height;
an upper window sash movably engaging the second vertical guide, and including a second frame and an upper window pane mounted to a second frame and having generally vertical inner and outer faces, the second frame defining a second height that is substantially greater than the first height; and
a simulated transom member extending horizontally across the outer face of the upper window pane and visually dividing the upper window pane into an upper portion and a lower portion.

11. The window assembly of claim 10, wherein:
the first frame defines a first window opening having a size and shape that is substantially similar to that of the first window opening.

12. The window assembly of claim 10, wherein:
the upper edge of the second window frame extends horizontally such that the upper portion of the upper window pane is substantially quadrilateral in shape.

13. The window assembly of claim 10, wherein:
the upper edge of the second window frame extends upwardly at the center, and the upper portion of the upper window pane defines a center height at the center and outer heights at upper ends of the stiles, wherein the central height is substantially greater than the outer heights.

14. The window assembly of claim 10, wherein:
the simulated transom member comprises an outer simulated transom member; and including:
an inner simulated transom member extending horizontally across the inner face of the upper window pane directly opposite the outer simulated transom member.

15. The window assembly of claim 10, wherein:
the simulated transom member defines an outer face having a horizontally extending groove therein.

16. A window assembly, comprising:
a frame comprising horizontally spaced-apart first and second vertically extending stiles and upper and lower frame members extending between and interconnecting the first and second stiles to form a horizontally and vertically enlarged frame opening that is generally quadrilateral in shape and defines a height and a width, wherein the height is substantially greater than the width;
a window pane having generally vertical inner and outer faces, and wherein the window pane is mounted to the frame in the enlarged frame opening;
a simulated transom member extending horizontally across a selected one of the inner and outer faces of the window pane and visually dividing the upper window pane into an upper portion defining a first height and a lower portion defining a second height, and wherein the second height is substantially greater than the first height, the simulated transom member defining an outer face having at least one horizontally extending groove providing a transom-like appearance.

17. The window assembly of claim 16, wherein:
the simulated transom member includes a pair of horizontally extending grooves in the outer face.

18. The window assembly of claim 17, wherein:
the grooves are parallel.

19. The window assembly of claim 16, wherein:
the simulated transom member comprises an outer simulated transom member, and including:
an inner simulated transom member extending horizontally across the inner face of the window pane.

20. The window assembly of claim 16, wherein:
the frame defines a substantially quadrilateral outer perimeter.
